(19) United States
(12) Patent Application Publication
(10) Pub. No.: US 2017/0316256 A1
(43) Pub. Date: Nov. 2, 2017

(54) AUTOMATIC ANIMATION TRIGGERING FROM VIDEO

(71) Applicant: Google Inc., Mountain View, CA (US)

(72) Inventors: Eunyoung KIM, Mountain View, CA (US); Ronald Frank WOTZLAW, Mountain View, CA (US)

(73) Assignee: Google Inc., Mountain View, CA (US)

(21) Appl. No.: 15/142,676

(22) Filed: Apr. 29, 2016

(51) Int. Cl. G06K 9/00

(52) U.S. Cl. CPC G06K 9/00302; G06K 9/00765; G06K 9/00228; G06T 2207/10016; G06T 2207/20081; G06K 2009/00738

(57) ABSTRACT

A computer-implemented method includes identifying interesting moments from a video. The video is received and includes image frames. Continual motion of one or more objects in the video is identified based on identifying foreground motion in the image frames. Video segments from the video that include the continual motion are generated. A segment score for each of the video segments is generated based on animation criteria. Responsive to one or more of segment scores exceeding the threshold animation score, one or more corresponding video segments are selected. An animation is generated based on the one or more corresponding video segments.

### BACKGROUND

Users often capture many videos on their smartphones, or other camera devices. Even though the videos were of interest to the user at the time of capture, the videos may be forgotten about and not watched again because users may not have the patience to watch even a minute-long video to wait for the interesting parts of the video.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations generally relate to a computer-implemented method to identify interesting moments from a video. The video is received and includes image frames. Continual motion of one or more objects in the video is identified based on identifying foreground motion in the image frames. Video segments from the video that include the continual motion are generated. A segment score for each of the video segments is generated based on animation criteria. Responsive to one or more of segment scores exceeding the threshold animation score, one or more corresponding video segments are selected. An animation is generated based on the one or more corresponding video segments.

In some implementations, the video is a first video and the operations further include responsive to the segment score for each of the video segments failing to exceed the threshold animation score, receiving a second video, and generating the animation for the second video responsive to the second video being associated with the segment scores exceeding the threshold animation score. The operations may further include generating an animation page that includes animations for a plurality of videos captured by a user, wherein the plurality of videos include the second video and additional videos, wherein each additional video has at least one respective video segment with the segment score exceeding the threshold animation score. In some implementations, generating video segments from the video includes generating video segments that each last one to three seconds. The operations may further include analyzing the video segments to perform at least one of: detecting a face in the video segments; determining an event associated with the video segments; determining a type of action associated with the continual motion in the video; extracting text from the video segments; and based on an emotional facial attribute of the face in the one or more of the image frames, identifying at least one of anger, contempt, fear, disgust, happiness, neutral, sadness, and surprise; where the animation criteria include results from analyzing the video segments.

In some implementations, the animation criteria include static camera motion and wherein the foreground motion exceeds a threshold amount of motion. In some implementations, generating the animation includes generating at least one of a cinemagraph, a face animation, and a visual effect animation. In some implementations, generating the animation includes inserting a link in the animation that upon selection causes the video to be displayed. In some implementations, the video is associated with a user and the operations further include receiving feedback from the user that includes at least one of an indication of approval, an indication of disapproval, and an identification of at least one of a person, an object, and a type of event to be included in the animation and revising the animation criteria based on the feedback.

In some implementations, a computer system includes one or more processors coupled to a memory. The system further includes a segmentation module stored in the memory and executable by the one or more processors, the segmentation module operable to receive the video, the video including image frames, identify continual motion of one or more objects in the video based on an identification of foreground motion in the image frames, and generate video segments from the video that include the continual motion. The system further includes a video processing module stored in the memory and executable by the one or more processors, the video processing module operable to generate a segment score for each of the video segments based on animation criteria, wherein the animation criteria includes a type of action associated with the continual motion and one or more labels associated with the video segment, determine whether the segment score for each of the video segments exceeds a threshold animation score, and responsive to one or more segment scores exceeding the threshold animation score, select one or more corresponding video segments. The system further includes an animation module stored in the memory and executable by the one or more processors, the animation module operable to generate an animation based on the one or more corresponding video segments and the segment scores.

In some implementations the method includes means for receiving the video, the video including image frames, means for identifying continual motion of one or more objects in the video based on an identification of foreground motion in the image frames, means for generating video segments from the video that include the continual motion, means for generating a segment score for each of the video segments based on animation criteria, means for determining whether the segment score for each of the video segments exceeds a threshold animation score, responsive to one or more segment scores exceeding the threshold animation score, means for selecting one or more corresponding video segments, and means for generating an animation based on the one or more corresponding video segments.

Other aspects may include corresponding methods, systems, apparatus, and computer program products.

The system and methods described below advantageously creates animations of interesting moments in a video for a user. The interesting moments may include interesting actions of people, children, babies, pets; a moment of an interesting event; or a moment that could become artistic.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 illustrates a block diagram of an example system that generates animations in accordance with some implementations.

FIG. 2 illustrates a block diagram of an example computing device that generates animations in accordance with some implementations.

FIG. 3 illustrates a graphic representation of an example user interface displayed on a desktop computer where the user interface includes animations associated with user videos in accordance with some implementations.

FIG. 4 illustrates a graphic representation of an example user interface displayed on a mobile device where the user interface includes animations associated with user videos in accordance with some implementations.

FIG. 5 illustrates a flowchart of an example method to organize images in accordance with some implementations.

### DETAILED DESCRIPTION

Users may be more likely to find a video interesting if the video has motion in it, such as jumping or laughing. A video application described herein advantageously generates an animation of interesting moments in videos based on motion. The video application obtains the user's consent to perform image analysis on videos and to generate animations. The video application may perform image analysis and generate an animation that includes objects of interest to the user where the objects of interest performs the motion. For example, such animations may include an animation of a user's daughter blowing out birthday candles or the user's dog jumping on a trampoline. In some implementations, the video application may receive feedback from the user and further refine generation of the animation based on the feedback. The feedback may be general, such as whether the user liked or disliked the video. The feedback may be specific, such as the user providing a preference for videos of abstract motion or identification of specific people.

The animation may include a single video segment. In some implementations, the animation may include multiple video segments. Generating the animation may include inserting a link in the animation that upon selection causes the video to be displayed. The animations may be displayed on a single page with titles for each animation that are automatically generated by the video application.

### Example System

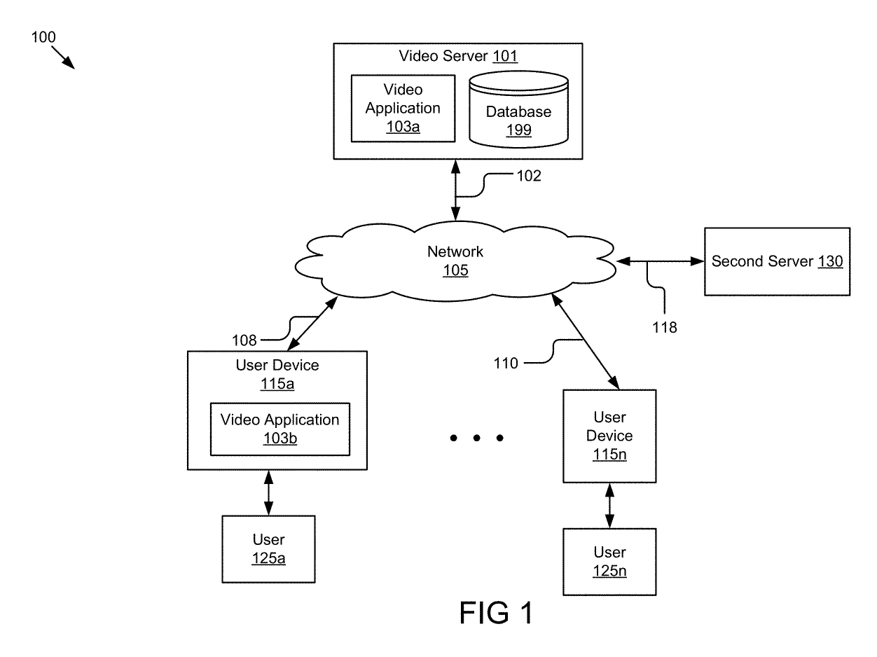

FIG. 1 illustrates a block diagram of an example system 100 that generates animations. The illustrated system 100 includes a video server 101, user devices 115a, 115n, a second server 130, and a network 105. Users 125a, 125n may be associated with respective user devices 115a, 115n. In some implementations, the system 100 may include other servers or devices not shown in FIG. 1. In FIG. 1 and the remaining figures, a letter after a reference number, e.g., “115a,” represents a reference to the element having that particular reference number. A reference number in the text without a following letter, e.g., “115,” represents a general reference to implementations of the element bearing that reference number.

In the illustrated implementation, the entities of the system 100 are communicatively coupled via a network 105. The network 105 may be a conventional type, wired or wireless, and may have numerous different configurations including a star configuration, token ring configuration or other configurations. Furthermore, the network 105 may include a local area network (LAN), a wide area network (WAN) (e.g., the Internet), and/or other interconnected data paths across which multiple devices may communicate. In some implementations, the network 105 may be a peer-to-peer network. The network 105 may also be coupled to or include portions of a telecommunications network for sending data in a variety of different communication protocols. In some implementations, the network 105 includes Bluetooth® communication networks, WiFi®, or a cellular communications network for sending and receiving data including via short messaging service (SMS), multimedia messaging service (MIMS), hypertext transfer protocol (HTTP), direct data connection, email, etc. Although FIG. 1 illustrates one network 105 coupled to the user devices 115 and the video server 101, in practice one or more networks 105 may be coupled to these entities.

The video server 101 may include a processor, a memory, and network communication capabilities. In some implementations, the video server 101 is a hardware server. The video server 101 is communicatively coupled to the network 105 via signal line 102. Signal line 102 may be a wired connection, such as Ethernet, coaxial cable, fiber-optic cable, etc., or a wireless connection, such as Wi-Fi®, Bluetooth®, or other wireless technology. In some implementations, the video server 101 sends and receives data to and from one or more of the user devices 115a, 115n and the second server 130 via the network 105. The video server 101 may include a video application 103a and a database 199.

The video application 103a may be code and routines operable to generate animations. In some implementations, the video application 103a may be implemented using hardware including a field-programmable gate array (FPGA) or an application-specific integrated circuit (ASIC). In some implementations, the video application 103a may be implemented using a combination of hardware and software.

The database 199 may store videos created by users 125 associated with user devices 115 and animations generated from the videos. In some implementations, the database 199 may store videos that were generated independent of the user devices 115. The database 199 may also store social network data associated with users 125, information received from the second server 130, user preferences for the users 125, etc.

The user device 115 may be a computing device that includes a memory and a hardware processor, for example, a camera, a laptop computer, a desktop computer, a tablet computer, a mobile telephone, a wearable device, a head-mounted display, a mobile email device, a portable game player, a portable music player, a reader device, a television with one or more processors embedded therein or coupled thereto, or other electronic device capable of accessing a network 105.

In the illustrated implementation, user device 115a is coupled to the network 105 via signal line 108 and user device 115n is coupled to the network 105 via signal line 110. Signal lines 108 and 110 may be a wired connection, such as Ethernet, coaxial cable, fiber-optic cable, etc., or a wireless connection, such as Wi-Fi®, Bluetooth®, or other wireless technology. User devices 115a, 115n are accessed by users 125a, 125n, respectively. The user devices 115a, 115n in FIG. 1 are used by way of example. While FIG. 1 illustrates two user devices, 115a and 115n, the disclosure applies to a system architecture having one or more user devices 115.

In some implementations, the user device 115 can be a mobile device that is included in a wearable device worn by the user 125. For example, the user device 115 is included as part of a clip (e.g., a wristband), part of jewelry, or part of a pair of glasses. In another example, the user device 115 can be a smart watch. The user 125 may view images from the video application 103 on a display of the device worn by the user 125. For example, the user 125 may view the images on a display of a smart watch or a smart wristband.

In some implementations, a video application 103b may be stored on a user device 115a. The video application 103 may include a thin-client video application 103b stored on the user device 115a and a video application 103a that is stored on the video server 101. For example, the video application 103b stored on the user device 115a may record video that is transmitted to the video application 103a stored on the video server 101 where an animation is generated from the video. The video application 103a may transmit the animation to the video application 103b for display on the user device 115a. The video application 103a stored on the video server 101 may include the same components or different components as the video application 103b stored on the user device 115a.

In some implementations, the video application 103 may be a standalone application stored on the video server 101. A user 125a may access the video application 103 via a web pages using a browser or via other software on the user device 115a. For example, the user 125a may upload a video stored on the user device 115a or from another source, such as from the second server 130, to the video application 103, which generates an animation.

The second server 130 may include a processor, a memory, and network communication capabilities. In some implementations, the second server 130 is a hardware server. The second server 130 is communicatively coupled to the network 105 via signal line 118. Signal line 118 may be a wired connection, such as Ethernet, coaxial cable, fiber-optic cable, etc., or a wireless connection, such as Wi-Fi®, Bluetooth®, or other wireless technology. In some implementations, the second server 130 sends and receives data to and from one or more of the video server 101 and the user devices 115a-115n via the network 105.

The second server 130 may provide data to the video application 103. For example, the second server 130 may be a separate server that generates videos that are used by the video application 103 to generate animations. In another example, the second server 130 may be a social network server that maintains a social network where the animations may be shared by a user 125 with other users of the social network. In yet another example, the second server 130 may include video processing software that analyzes videos to identify objects, faces, events, a type of action, text, etc. The second server 130 may be associated with the same company that maintains the video server 101 or a different company.

As long as a user consents to the use of such data, the second server 130 may provide the video application 103 with profile information or profile images of a user that the video application 103 may use to match a person in an image with a corresponding social network profile. In another example, if the user consents to the use of such data, the second server 130 may provide the video application 103 with information related to entities identified in the images used by the video application 103. For example, the second server 130 may include an electronic encyclopedia that provides information about landmarks identified in the images, an electronic shopping website that provides information for purchasing entities identified in the images, an electronic calendar application that provides, subject to user consent, an event name associated with a video, a map application that provides information about a location associated with a video, etc.

In situations in which the systems and methods discussed herein may collect or use personal information about users (e.g., user data, information about a user's social network, user's location, user's biometric information, user's activities and demographic information), users are provided with opportunities to control whether information is collected, whether the personal information is stored, whether the personal information is used, and how the information about the user is collected, stored, and used. That is, the systems and methods discussed herein collect, store, and/or use user personal information only upon receiving explicit authorization from the relevant users to do so. For example, a user is provided with control over whether programs or features collect user information about that particular user or other users relevant to the program or feature. Each user for which personal information is to be collected is presented with one or more options to allow control over the information collection relevant to that user, to provide permission or authorization as to whether the information is collected and as to which portions of the information are to be collected. For example, users can be provided with one or more such control options over a communication network. In addition, certain data may be treated in one or more ways before it is stored or used so that personally identifiable information is removed. As one example, a user's identity information may be treated, e.g., anonymized, so that no personally identifiable information can be determined. As another example, a user's geographic location may be generalized to a larger region so that the user's particular location cannot be determined.

### Example Computing Device

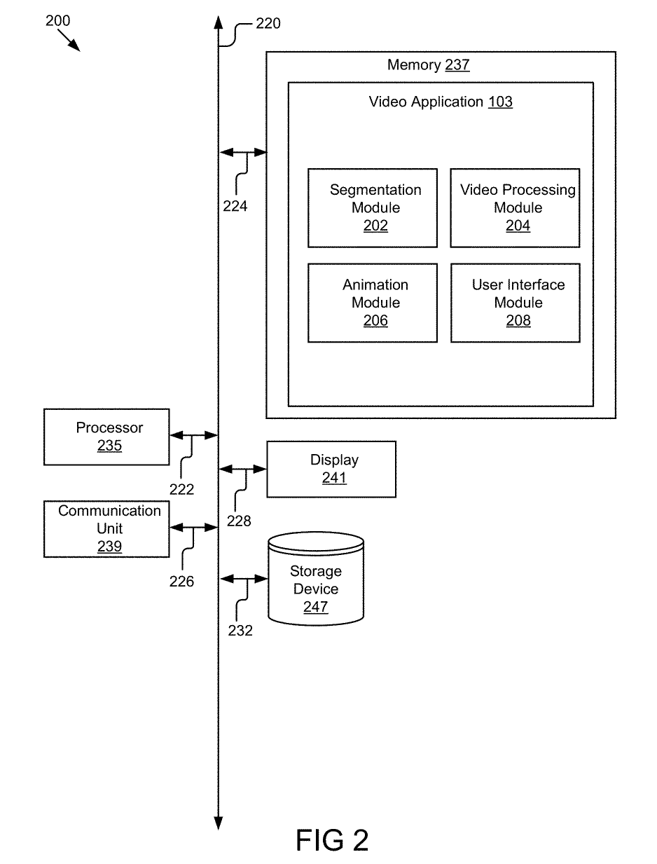

FIG. 2 illustrates a block diagram of an example computing device 200 that generates animations. The computing device 200 may be a video server 101 or a user device 115. The computing device 200 may include a processor 235, a memory 237, a communication unit 239, a display 241, and a storage device 247. A video application 103 may be stored in the memory 237. The components of the computing device 200 may be communicatively coupled by a bus 220.

The processor 235 includes an arithmetic logic unit, a microprocessor, a general purpose controller or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. Although FIG. 2 includes a single processor 235, multiple processors 235 may be included. Other processors, operating systems, sensors, displays and physical configurations may be part of the computing device 200. The processor 235 is coupled to the bus 220 for communication with the other components via signal line 222.

The memory 237 stores instructions that may be executed by the processor 235 and/or data. The instructions may include code for performing the techniques described herein. The memory 237 may be a dynamic random access memory (DRAM) device, a static RAM, or some other memory device. In some implementations, the memory 237 also includes a non-volatile memory, such as a (SRAM) device or flash memory, or similar permanent storage device and media including a hard disk drive, a floppy disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the video application 103, which is described in greater detail below. The memory 237 is coupled to the bus 220 for communication with the other components via signal line 224.

The communication unit 239 transmits and receives data to and from at least one of the user device 115, the video server 101, and the second server 130 depending upon where the video application 103 may be stored. In some implementations, the communication unit 239 includes a port for direct physical connection to the network 105 or to another communication channel. For example, the communication unit 239 includes a universal serial bus (USB), secure digital (SD), category 5 cable (CAT-5) or similar port for wired communication with the user device 115 or the video server 101, depending on where the video application 103 may be stored. In some implementations, the communication unit 239 includes a wireless transceiver for exchanging data with the user device 115, video server 101, or other communication channels using one or more wireless communication methods, including IEEE 802.11, IEEE 802.16, Bluetooth® or another suitable wireless communication method. The communication unit 239 is coupled to the bus 220 for communication with the other components via signal line 226.

In some implementations, the communication unit 239 includes a cellular communications transceiver for sending and receiving data over a cellular communications network including via short messaging service (SMS), multimedia messaging service (MMS), hypertext transfer protocol (HTTP), direct data connection, e-mail or another suitable type of electronic communication. In some implementations, the communication unit 239 includes a wired port and a wireless transceiver. The communication unit 239 also provides other conventional connections to the network 105 for distribution of files and/or media objects using standard network protocols including, but not limited to, user datagram protocol (UDP), TCP/IP, HTTP, HTTP secure (HTTPS), simple mail transfer protocol (SMTP), SPDY, quick UDP internet connections (QUIC), etc.

The display 241 may include hardware operable to display graphical data received from the video application 103. For example, the display 241 may render graphics to display an animation. The display 241 is coupled to the bus 220 for communication with the other components via signal line 228. Other hardware components that provide information to a user may be included as part of the computing device 200. In some implementations, such as where the computing device 200 is a video server 101, the display 241 may be optional. In some implementations, the computing device 200 may not include all the components. In implementations where the computing device 200 is a wearable device, the computing device 200 may not include storage device 247. In some implementations, the computing device 200 may include other components not listed here, such as one or more cameras, sensors, a battery, etc.

The storage device 247 may be a non-transitory computer-readable storage medium that stores data that provides the functionality described herein. In implementations where the computing device 200 is the video server 101, the storage device 247 may include the database 199 in FIG. 1. The storage device 247 may be a DRAM device, a SRAM device, flash memory or some other memory device. In some implementations, the storage device 247 also includes a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a permanent basis. The storage device 247 is coupled to the bus 220 for communication with the other components via signal line 232.

In the illustrated implementation shown in FIG. 2, the video application 103 includes a segmentation module 202, a video processing module 204, an animation module 206, and a user interface module 208. Other modules and/or configurations are possible.

The segmentation module 202 may be operable to identify continual motion in a video and segment the video into video segments based on the continual motion. In some implementations, the segmentation module 202 may be a set of instructions executable by the processor 235 to segment the video. In some implementations, the segmentation module 202 may be stored in the memory 237 of the computing device 200 and can be accessible and executable by the processor 235.

The segmentation module 202 may receive a video that includes image frames. The video may be associated with a user. In some implementations, the segmentation module 202 may receive a video recorded on the same device 200 where the video application 103 is stored. In some implementations, the segmentation module 202 may be stored on a device 200 that is the video server 101 of FIG. 1 and the segmentation module 202 may receive the video from the video application 103b stored on the user device 115. In some implementations, the segmentation module 202 may receive the video from a second server 130, such as a second server 130 that hosts a social network where a second user shares the video with the user.

In some implementations, the segmentation module 202 performs pre-processing and post-processing of the video before identifying the continual motion. For example, the segmentation module 202 may perform pre-processing that includes a spatial and temporal smoothing of the image frames to reduce background motion. The spatial and temporal smoothing may be used to remove interference from weather conditions, such as rain and snow. The post-processing may include morphological processing to remove small moving objects, such as the movement of leaves on trees. As a result of the pre- and post-processing, the segmentation module 202 may more easily identify motion in the foreground of the image frames.

In some implementations, the segmentation module 202 classifies pixels in an image frame as belonging to either a background or a foreground. The segmentation module 202 may perform the classification on all image frames of the video or a subset of image frames of the video. In some implementations the segmentation module 202 identifies the background and the foreground in a subset of the image frames based on a timing of the image frames. For example, the segmentation module 202 may perform classification on every third frame in the video. In another example, the video processing module 202 may perform classification on a subset of the frames in the video, e.g., only I-frames, I-frames and a few or all of predicted picture frames (P-frames), etc.

The segmentation module 202 may compare the foreground in the image frames of the video to identify foreground motion. For example, the segmentation module 202 may use different techniques to identify motion in the foreground, such as frame differencing, adaptive median filtering, and background subtraction. This process advantageously identifies motion of objects in the foreground. For example, in a video of a person doing a cartwheel outside, the segmentation module 202 may ignore motion that occurs in the background, such as a swaying of the trees in the wind, but the segmentation module 202 identifies the person performing the cartwheel because the person is in the foreground. In some implementations, the segmentation module 202 identifies static camera motion, which is motion that is independent of camera motion, such as tilting and shaking. This can occur during pre-processing or as part of the process to identify motion in the foreground.

The segmentation module 202 generates video segments from the video that include the continual motion. For example, a five-minute video may have four discrete instances of continual motion. In some implementations, the segmentation module 202 determines whether the video segments are longer than a predetermined length and cuts the video segments to fall below the threshold length. For example, because people may be more interested in seeing the beginning of the continual motion than the end, the segmentation module 202 may cut off the end of video segments that exceed the predetermined length.

In some implementations, the segmentation module 202 generates video segments that fall within a predetermined range, such as one to three seconds. The segmentation module 202 may determine how to cut a video segment based on a completion of the continual motion in the video. The segmentation module 202 may identify a start and an intermediate endpoint of continual motion within the segment and pick a sub-segment that includes both these points. For example, if the video is of a girl doing multiple cartwheels, the start point may be the start of a first cartwheel and the intermediate end point may be the end of the first cartwheel. In another example, the segmentation module 202 may identify a segment based on different types of motion. For example, a first subsegment may be a cartwheel and a second subsegment may be a jumping celebration.

The video processing module 204 may be operable to generate a segment score for each of the video segments. In some implementations, the video processing module 204 may be a set of instructions executable by the processor 235 to generate the segment score. In some implementations, the video processing module 204 may be stored in the memory 237 of the computing device 200 and can be accessible and executable by the processor 235.

In some implementations, the video processing module 204 receives the video segments from the segmentation module 202 or retrieves the video segments from the storage device 247. The video processing module 204 may generate a segment score for each of the video segments based on animation criteria.

In some implementations, the video processing module 204 generates the segment score based on information determined by the segmentation module 202. For example, the animation criteria may include static camera motion and foreground motion, such that the video processing module 204 generates a segment score that indicates a more interesting video segment for a video segment that has minimal static camera motion and sufficient foreground motion. The video processing module 204 may generate a segment score based on the foreground motion exceeding a threshold amount of motion. In some implementations, the video processing module 204 may determine the threshold amount of motion based on a percentage of pixel change between successive frames in the video segment.

In some implementations, the video processing module 204 may analyze the video segments before generating the segment score. The video processing module 204 may perform object recognition to identify objects in the video segments. Upon user consent, the video processing module 204 may perform object recognition that includes identifying a face in the video segments and determining an identity of the face. The video processing module 204 may compare an image frame of the face to publicly available images of people, compare the image frame to other members that use the video application 103, etc. In some implementations, upon user consent, the video processing module 204 may request identifying information from the second server. For example, the second server 130 may maintain a social network and the video processing module 204 may request profile images or other images of social network users that are connected to the user associated with the video. In some implementations, upon user consent, the video processing module 204 may employ facial recognition techniques to people in image frames of the video segments to identify people associated with the faces.

The video processing module 204 may apply a label to a video segment for identified objects and, if the user has provided consent, for people in the video segment. The label may be metadata that is associated with the video segment. For example, for a video segment of the user's daughter blowing out a birthday cake, the video processing module 204 may associate a label with the daughter's name, names of other people in the video segment, and a label for the birthday cake.

In some implementations, the animation criteria may include labels for types of objects and the video processing module 204 may assign a segment score based on labels associated with a video segment. The video processing module 204 may assign the segment score based on the type of object labels associated with the video segment. The video processing module 204 may compare object labels to a list of positive objects and a list of negative objects that include objects that are commonly recognized as being positive and negative, respectively. For example, the list of positive objects may include famous landmarks, birthday cakes, and puppies. In another example, the list of negative objects may include trash, blood, and vomit.

In some implementations, when the user consents to the use of user data, the video processing module 204 assigns the segment score based on personalization information for a user associated with the video. For example, the video processing module 204 maintains a user profile for a user that includes a list of positive objects that the user associated with the video has identified as being positive. The video processing module 204 may determine personalization information, subject to user consent, based on explicit information provided by the user, implicit information based on the user's reactions to videos, such as comments provided on video websites, activity in social network applications, etc. In some implementations, the video processing module 204 determines user preferences based on the types of videos associated with the user. For example, the video processing module 204 may determine that the user prefers abstract videos based on recording more videos of abstract things, such as random motion, swirling water, and floating trash bags, than videos of people and animals.

The segment score may be further based on identifying a relationship between the user associated with the video segment and labels for people in the video segment. For example, the segment score may be indicative of a more important video segment when the video segment includes a label for the user's daughter.

The video processing module 204 may analyze the video segments to determine a type of action associated with the continual motion. For example, the video processing module 204 may use a vector based on continual motion to compare the continual motion with continual motion in known videos. The video processing module 204 may use the vector to identify a person walking a dog, punching another person, catching a fish, etc. In another example, the video processing module 204 may perform image recognition to identify objects and types of motion associated with the objects in other past videos to identify the action. For example, the video processing module 204 identifies a trampoline and determines that a person is jumping on the trampoline based on trampolines being associated with jumping, a cake being associated with cutting or blowing out a birthday cake, skis being associated with skiing, etc.

In some implementation, the video processing module 204 identifies a person's pose in the video segment. The video processing module 204 may compare a pose in a video segment to a library of known poses. For example, the person may begin the continual motion in an aggravated pose, a tense pose, an excited pose, etc. The animation criteria may be based on the type of action and/or the pose. The video processing module 204 may generate the segment score based on the type of action and/or the pose.

The video processing module 204 may extract text from the video segments. The video processing module 204 may use the text to help determine information for one of the other animation criteria, such as a type of event being depicted in the video segment. For example, the video segment may be of a basketball player making a basket and the text may be from a sign held by a fan in the video of the basketball game, such as “3-pointer” or “dunk.” The video processing module 204 may use the text to determine a sentiment associated with the video segment. For example, the video segment may be of protesters at a rally and the video processing module 204 may identify text on a sign of one of the protesters. In some implementations, the video processing module 204 may extract text from audio in the video segment by performing audio-to-text transcription. In some implementations, the animation criteria may include text and the video processing module 204 may generate the segment score based on text identified in a video segment.

In some implementations, when the user (i.e., the owner of the video segment and/or the people depicted in the video segment) provides consent to such analysis, the video processing module 204 determines an emotional facial attribute of faces in the image frames. For example, the video processing module 204 may identify the locations of facial features and compare the locations to locations that are associated with emotional states to identify corresponding emotions. For example, the video processing module 204 may determine that in an image frame, the person's lips are upturned, the person's cheeks are raised, and there are wrinkles at the edges of the person's eyes. As a result, the person is smiling and therefore associated with the emotional state of happiness. The video processing module 204 may use machine learning and training sets to determine the emotional states. The emotional states may include, but are not limited to, anger, contempt, fear, disgust, happiness, neutral, sadness, or surprise.

In some implementations, the animation criteria include the emotional facial attributes and the video processing module 204 assigns the segment score based on a type of emotional facial attribute. For example, video segments of people associated with positive emotional states, such as happiness, may be associated with a more positive score than video segments of people associated with negative emotional states, such as anger, contempt, fear, disgust, or sadness.

In some implementations, the video processing module 204 may determine an event associated with the video segment. The video processing module 204 may determine the event based on the labels for objects and people associated with the video segment. For example, the video processing module 204 may determine that the event was a birthday party based on a birthday cake label. Certain objects may be associated with certain events, for example, cakes are associated with birthdays and weddings, basketball is associated with a court, etc. In another example, people may be associated with events, such as people wearing uniforms with certain events that occur during school hours, people sitting in pews with a church gathering, people around a table with plates with dinner, etc. The animation criteria may include a type of event and the video processing module 204 may generate the segment score based on the type of event.

In some implementations, the video processing module 204 may use additional sources of data to identify the event. For example, the video processing module 204 may determine one or more of the date, the time, and the location where the video was taken based on metadata associated with the video and, upon user consent, request event information associated with the data and the time from a calendar application associated with the user. In some implementations, the video processing module 204 may request the event information from a second server 130 that manages the calendar application. In some implementations, the video processing module 204 may determine the event from publicly available information. For example, the video processing module 204 may use one or more of the date, the time, and the location associated with the video to determine that the video segment includes footage of a rock show. The video processing module 204 may associate a label that includes identifying information for the event. For example, the video processing module 204 may add the label: “Ava's first birthday party” based on the title of the calendar event.

The video processing module 204 may determine whether the segment score for each of the video segments exceeds a threshold animation score. Video segments with segment scores that exceed the threshold animation score may be selected for the animation module 206 to generate one or more animations. Video segments that fail to exceed the threshold animation score may be skipped. The video processing module 204 may proceed with analyzing a subsequent video from a group of video segments for a video. For example, the video application 103 may process a series of videos associated with a user.

The video processing module 204 may apply segment scores that are on a scale, such as from 1 to 10. For example, where the animation criteria includes foreground motion, 1 may indicate little motion and 10 may indicate frantic motion. In some implementations, the video processing module 204 generates a segment score that is based on a combination of the different animation criteria. In some implementations, the video processing module 204 normalizes the segment score based on the number of animation criteria. In some implementations, the video processing module 204 weights the animation criteria to favor some animation criteria over others. For example, foreground motion may be weighted as more important than other animation criteria.

In some implementations, the video processing module 204 may receive feedback from a user and modify the animation criteria and/or the technique for generating the segment score accordingly. For example, if a user provides an indication of approval (e.g., a thumbs up, a +1, a like, saving an animation to the user's gallery, etc.) of an animation that includes a label for the user's dog and the video processing module 204 may include the user's dog in a list of positive objects. In another example, the user may explicitly state that the user enjoys animations where the event type is a rock show. The video processing module 204 may update personalization information associated with the user, such as a user profile, to include the rock show as a preferred event type. In some implementation, the feedback includes an indication of disapproval (a thumbs down, a −1, a dislike, etc.). In some implementations, the indications of approval and/or disapproval are determined based on comments provided by a user. In some implementations, the feedback includes an identification of a person, an object, or a type of event that the user wants to be included in the animation. In some implementations, the feedback may include a preference for types of animations. For example, the user may indicate a preference for artistic animations.

The animation module 206 may be operable to generate an animation from one or more video segments. In some implementations, the animation module 206 can be a set of instructions executable by the processor 235 to provide the functionality described below for generating the animation. In some implementations, the animation module 206 can be stored in the memory 237 of the computing device 200 and can be accessible and executable by the processor 235.

In some implementations, the animation module 206 receives selected video segments from the video processing module 204. The selected video segments may be video segments that are associated with segment scores that exceed a threshold animation score. In some implementations, the animation module 206 may retrieve the selected video segments from the storage device 247.

The animation may take many forms. For example, the animation may include the selected video segment from all selected video segments associated with a video that has a segment score indicative of the most interesting video segment. In another example, the animation may include multiple selected video segments that are combined to form the animation. The animation module 206 may combine a predetermined number of the selected video segments to form the animation. For example, the animation module 206 may rank the selected video segments from most interesting to least interesting based on the segment scores and generate an animation from one to five of the highest ranked video segments. In some implementations, the animation module 206 generates the animation based on segment scores associated with one or more selected video segments. For example, the animation module 206 generates an animation from the video segment with a segment score that indicates that the video segment is the most interesting. In some implementations, the animation module 206 includes transitions between the video segments, such as fading or cross-fading one video segment into a subsequent video segment, inserting blank frames between video segments, etc.

In some implementations, the animation module 206 may generate an animation that is a cinemagraph, a face animation, a visual effect animation, or an artistic animation. The animation module 206 may generate the cinemagraph by selecting a background from one of the image frames and imposing movement from the foreground from other image frames on top of the background. For example, an animation of a person doing a cartwheel may have a static outdoor background with only the person doing the cartwheel moving. The animation module 206 may create a face animation by taking each image frame in the one or more selected video segments and cropping the image frames to create a closer view of a face in the one or more selected video segments. The animation module 206 may generate animations from objects with a similar technique. The animation module 206 may generate a visual effect animation that applies to one or more selected video segments. For example, the animation module 206 may overlay animation effects, such as putting a cartoon dog nose on a selected video segment of a person laughing. In some implementations, the animation includes an animated graphics interchange format (GIF) file or the image frames included in the one or more video segments selected for the animation. The animation module 206 may generate the artistic animation by creating an abstraction of the one or more selected video segments. The abstraction could include, for example, an impressionistic version of the video. In some implementations, the animation module 206 may generate an animation that includes slow motion, a constant background, artistic overlays, and color fades.

The user interface module 208 may be operable to provide information to a user. In some implementations, the user interface module 208 can be a set of instructions executable by the processor 235 to provide the functionality described below for providing information to a user. In some implementations, the user interface module 208 can be stored in the memory 237 of the computing device 200 and can be accessible and executable by the processor 235.

The user interface module 208 may receive instructions from the other modules in the video application 103 to generate graphical data operable to display a user interface. For example, the user interface module 208 may generate a user interface that displays an animation created by the animation module 206.

In some implementations, the user interface module 208 may receive animations from the animation module 206 for videos associated with a user where the segment scores associated with video segments exceeded the animation threshold. The user interface module 208 may generate an animation page that includes the animations.

The user interface module 208 may generate graphical data for displaying animations with a variety of different features. The animations may automatically play. Alternatively or additionally, the animations may have to be selected, e.g., by a user, to play. In some implementations, a user may be able to configure automatic playback as a system setting. The user interface module 208 may include different rendering options, such as forward-backward rendering and forward rendering. In some implementations, the rendering options may be determined based on content and/or motion.

The user interface module 208 may generate graphical data to display animations that include a link to the full video such that, responsive to a user clicking on the animation the user interface may display the original video or cause a new webpage to open that includes the full video.

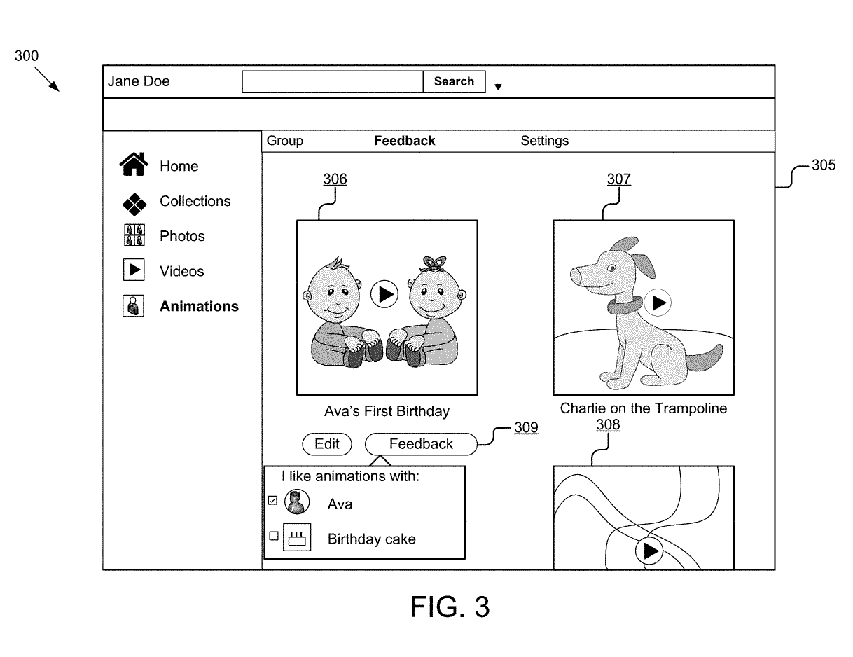

FIG. 3 illustrates a graphic representation of a user interface 300 displayed on a desktop computer where the user interface includes animations associated with user videos. The user interface 300 includes an animation page 305 that includes animations 306, 307, 308 generated from videos associated with the user. Animation 306 includes a video segment of Ava blowing out her birthday cake. Animation 307 includes a video segment of Charlie the dog jumping on a trampoline. Animation 308 is an animation effect where when the lines swirl together when the animation is playing.

The user interface module 208 may determine titles for the animations based on labels associated with video segments used in the animations. For example, animation 306 is titled based on the label “Ava's first birthday,” which was derived from the calendar entry associated with the event.

In some implementations, the user interface module 208 may generate an option for a user to provide feedback on the animations. For example, FIG. 3 includes a feedback button 309 that the user can select to view a drop-down menu that includes objects that the user wants to add as explicit interests. The user interface module 208 may provide the objects based on labels associated with the one or more video segments used to create the list of objects that the user may select as explicit interests.

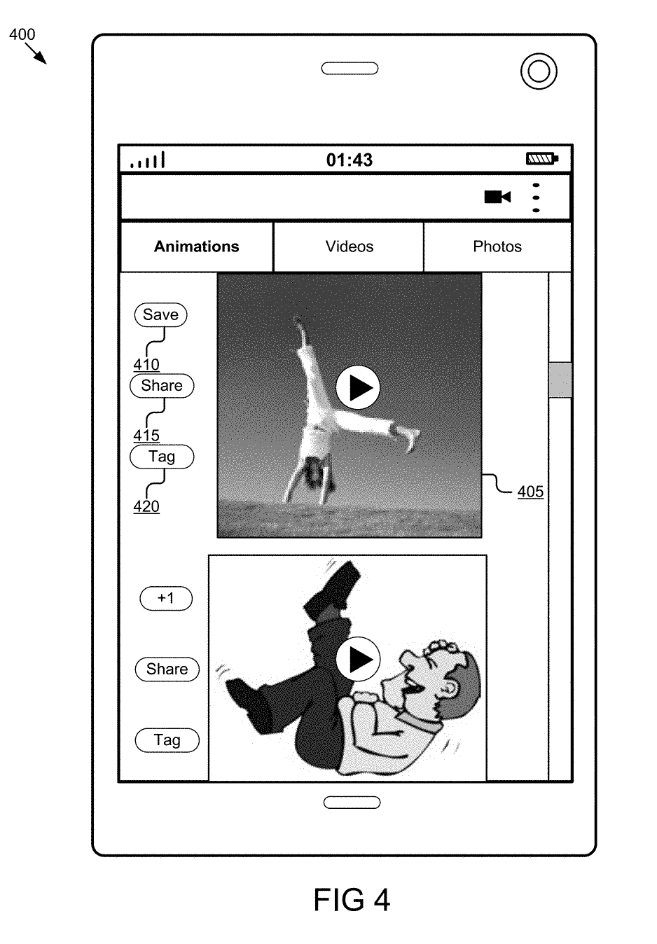

FIG. 4 illustrates a graphic representation of a user interface 400 displayed on a mobile device where the user interface includes animations associated with user videos. In this example, because there is reduced screen space the animations are displayed along a vertical direction, e.g. so that a user can scroll through the different animations. The animations include a first animation 405 of a woman doing a cartwheel and a second animation 406 of a man laughing. The user interface module 208 generates a user interface 400 with several actions that a user can perform. The user can provide an indication of approval of the first animation 405 by selecting the save icon 410 to save the first animation 405 to the user's gallery. The user can share the first animation 405, e.g., on a social network, via a message, via email, etc. by selecting the share icon 415. If the user selects the share icon 415, the user interface module 208 may cause multiple options for different websites or applications where the animation could be shared including a social network, a video website, or an email application. In some implementations, the video processing module 204 may fail to identify a person in an animation. For example, the first animation 405 may fail to include an image of the person's face that is clear enough to make an identification. As a result, the user interface module 208 may include a tag icon 420 that can be used to identify the person in the animation. In some implementations, once the user provides a name of the person in the video, the video processing module 204 applies a label to the animation based on the tag.

### Example Method

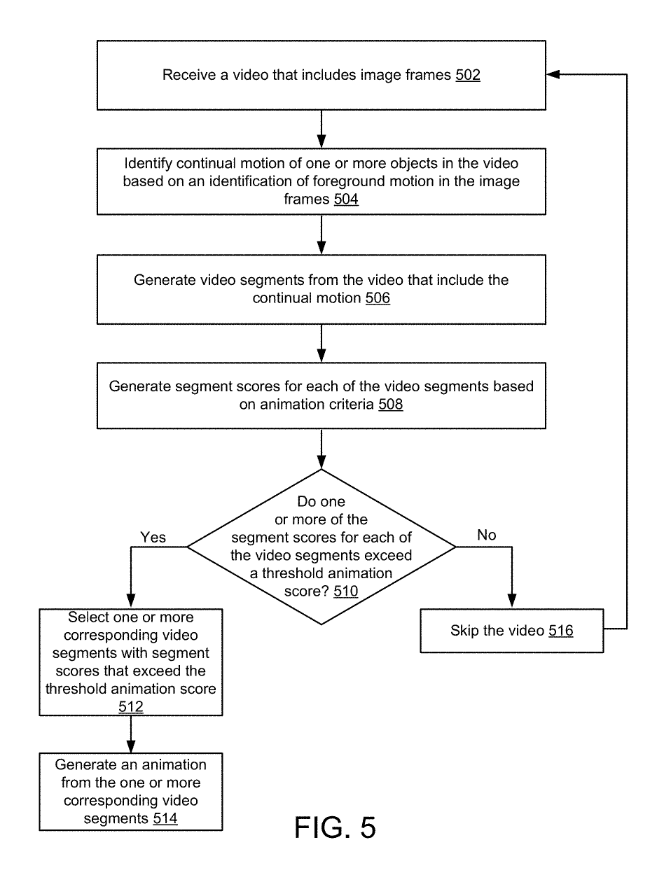

FIG. 5 illustrates a flowchart of an example method 500 to organize images. In some implementations, the steps in FIG. 5 may be performed by the video application 103 of FIG. 1 and/or FIG. 2.

At block 502, a video is received that includes image frames. For example, the video includes a mixture of people laughing and people with neutral expressions. At block 504, continual motion of one or more object in the video is identified based on an identification of foreground motion in the image frames. For example, the objects are the people and the continual motion is the movement of the people laughing. At block 506, video segments from the video that include the continual motion are generated. For example, the video segments include different clips of the people laughing.

At block 508, segments scores are generated for each of the video segments based on animation criteria. Depending on user consent, the animation criteria may include an identity of people or objects in the video, positive sentiment associated with the people, and identified actions. For example, the animation criteria may include, subject to user consent, an identity of the people and a degree of separation between the people and the user associated with the video in a social network. Continuing with the above example, the video application 103 may identify that the people in the video have positive sentiment because they are smiling and the action is laughing. The video application 103 may assign segment scores associated with more interest for the video segments that include people that are directly connected to the user in the social network, people that are laughing, and wider smiles on the people.

At block 510, it is determined whether one or more of the segment scores for each of the video segments exceed a threshold animation score. For example, the video segments with people that are directly connected to the user where the people are laughing have segment scores that exceed the threshold animation score. If yes, at block 512 the one or more corresponding video segments with segment scores that exceed the threshold animation score are selected. At block 514 an animation is generated from the corresponding video segments.

If no, at block 516 the video is skipped and method 500 continues for the next video starting from block 502. For example, the method may be applied to all videos associated with a user and the next video is the next video in a series of videos associated with the user.

While blocks 502 to 516 are illustrated in a particular order, other orders are possible with intervening steps. In some implementations, some blocks may be added, skipped, or combined.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the implementations can be described above primarily with reference to user interfaces and particular hardware. However, the implementations can apply to any type of computing device that can receive data and commands, and any peripheral devices providing services.

Reference in the specification to “some implementations” or “some instances” means that a particular feature, structure, or characteristic described in connection with the implementations or instances can be included in at least one implementation of the description. The appearances of the phrase “in some implementations” in various places in the specification are not necessarily all referring to the same implementations.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The implementations of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including floppy disks, optical disks, ROMs, CD-ROMs, magnetic disks, RAMs, EPROMs, EEPROMs, magnetic or optical cards, flash memories including USB keys with non-volatile memory, or any type of media suitable for storing electronic instructions, each coupled to a computer system bus.

The specification can take the form of some entirely hardware implementations, some entirely software implementations or some implementations containing both hardware and software elements. In some implementations, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

In situations in which the systems discussed above collect or use personal information, the systems provide users with an opportunity to control whether programs or features collect user information (e.g., information about a user's social network, social actions or activities, profession, a user's preferences, or a user's current location), or control whether and/or how to receive content from the server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the server.

What is claimed is:

1. A computer-implemented method to identify interesting moments from a video, the method comprising:
receiving the video, the video including image frames;
identifying continual motion of one or more objects in the video based on an identification of foreground motion in the image frames;
generating video segments from the video that include the continual motion;
generating a segment score for each of the video segments based on animation criteria;
determining whether the segment score for each of the video segments exceeds a threshold animation score;
responsive to one or more segment scores exceeding the threshold animation score, selecting one or more corresponding video segments; and
generating an animation based on the one or more corresponding video segments.

2. The computer-implemented method of claim 1, wherein the video is a first video and further comprising:
responsive to the segment score for each of the video segments failing to exceed the threshold animation score, receiving a second video; and
generating the animation for the second video responsive to the second video being associated with the segment scores exceeding the threshold animation score.

3. The method of claim 2, further comprising:
generating an animation page that includes animations for a plurality of videos captured by a user, wherein the plurality of videos include the second video and additional videos, wherein each additional video has at least one respective video segment with the segment score exceeding the threshold animation score.

4. The method of claim 1, wherein generating video segments from the video includes generating video segments that each last one to three seconds.

5. The method of claim 1, further comprising analyzing the video segments to perform at least one of:
detecting a face in the video segments;
determining an event associated with the video segments;
determining a type of action associated with the continual motion in the video;
extracting text from the video segments; and
based on an emotional facial attribute of the face in the one or more of the image frames, identifying at least one of anger, contempt, fear, disgust, happiness, neutral, sadness, and surprise; and
wherein the animation criteria include results from analyzing the video segments.

6. The method of claim 1, wherein the animation criteria include static camera motion and wherein the foreground motion exceeds a threshold amount of motion.

7. The method of claim 1, wherein generating the animation includes generating at least one of a cinemagraph, a face animation, and a visual effect animation.

8. The method of claim 1, wherein generating the animation includes inserting a link in the animation that upon selection causes the video to be displayed.

9. The method of claim 1, wherein the video is associated with a user and further comprising:
receiving feedback from the user that includes at least one of an indication of approval, an indication of disapproval, and an identification of at least one of a person, an object, and a type of event to be included in the animation; and
revising the animation criteria based on the feedback.

10. A computer system comprising:
one or more processors coupled to a memory;
a segmentation module stored in the memory and executable by the one or more processors, the segmentation module operable to receive the video, the video including image frames, identify continual motion of one or more objects in the video based on an identification of foreground motion in the image frames, and generate video segments from the video that include the continual motion;
a video processing module stored in the memory and executable by the one or more processors, the video processing module operable to generate a segment score for each of the video segments based on animation criteria, wherein the animation criteria includes a type of action associated with the continual motion and one or more labels associated with the video segment, determine whether the segment score for each of the video segments exceeds a threshold animation score, and responsive to one or more segment scores exceeding the threshold animation score, select one or more corresponding video segments; and
an animation module stored in the memory and executable by the one or more processors, the animation module operable to generate an animation based on the one or more corresponding video segments and the segment scores.

11. The system of claim 10, wherein the video processing module is further operable to:
responsive to the segment score for each of the video segments failing to exceed the threshold animation score, skip the first video;
receive a second video; and
generate the animation for the second video responsive to the second video being associated with the segment scores exceeding the threshold animation score.

12. The system of claim 10, wherein the animation module is further operable to:
generate an animation page that includes animations for a plurality of videos captured by a user, wherein the plurality of videos include the second video and additional videos, wherein each additional video has at least one respective video segment with the segment score exceeding the threshold animation score.

13. The system of claim 10, wherein the segmentation module is operable to generate video segments from the video that each last one to three seconds.

14. The system of claim 10, wherein the video processing module is further operable to analyze the video segments to perform at least one of:
detecting a face in the video segments;
determining an event associated with the video segments;
determining a type of action associated with the continual motion in the video;
extracting text from the video segments; and
based on an emotional facial attribute of the face in the one or more of the image frames, identifying at least one of anger, contempt, fear, disgust, happiness, neutral, sadness, and surprise; and
wherein the animation criteria include results from analyzing the video segments.

15. A non-transitory computer storage medium encoded with a computer program, the computer program comprising instructions that, when executed by one or more computers, cause the one or more computers to perform operations comprising:
receiving a video, the video including image frames;
identifying continual motion of one or more objects in the video based on an identification of foreground motion in the image frames;
generating video segments from the video that include the continual motion;
generating a segment score for each of the video segments based on animation criteria;
determining whether the segment score for each of the video segments exceeds a threshold animation score;
responsive to one or more segment scores exceeding the threshold animation score, selecting one or more corresponding video segments; and
generating an animation based on the one or more corresponding video segments.

16. The computer storage medium of claim 15, wherein the video is a first video and the instructions cause the one or more computers to perform further operations comprising:
responsive to the segment score for each of the video segments failing to exceed the threshold animation score receiving a second video; and
generating the animation for the second video responsive to the second video being associated with the segment scores exceeding the threshold animation score.

17. The computer storage medium of claim 15, wherein the instructions cause the one or more computers to further perform operations comprising:
generating an animation page that includes animations for a plurality of videos captured by a user, wherein the plurality of videos include the second video and additional videos, wherein each additional video has at least one respective video segment with the segment score exceeding the threshold animation score.

18. The computer storage medium of claim 15, wherein generating video segments from the video includes generating video segments that each last one to three seconds.

19. The computer storage medium of claim 15, wherein the instructions cause the one or more computers to further perform operations comprising analyzing the video segments, wherein analyzing the video segments includes at least one of:
detecting a face in the video segments;
determining an event associated with the video segments;
determining a type of action associated with the continual motion in the video;
extracting text from the video segments; and
based on an emotional facial attribute of the face in the one or more of the image frames, identifying at least one of anger, contempt, fear, disgust, happiness, neutral, sadness, and surprise; and
wherein the animation criteria include results from analyzing the video segments.

20. The computer storage medium of claim 15, wherein the animation criteria include static camera motion and wherein the foreground motion exceeds a threshold amount of motion.
